(19) United States
(12) Patent Application Publication
(10) Pub. No.: US 2026/0185663 A1
(43) Pub. Date: Jul. 2, 2026

(54) HYDROGEN SUPPLY SYSTEM

(71) Applicant: TOYOTA JIDOSHA KABUSHIKI KAISHA, Toyota-shi Aichi-ken (JP)

(72) Inventor: Shota WATANABE, Toyota-shi Aichi-ken (JP)

(73) Assignee: TOYOTA JIDOSHA KABUSHIKI KAISHA, Toyota-shi Aichi-ken (JP)

(21) Appl. No.: 19/430,995

(22) Filed: Dec. 23, 2025

(30) Foreign Application Priority Data
Dec. 26, 2024 (JP) 2024-230563

(51) Int. Cl. F17C 5/00

(52) U.S. Cl. CPC F17C 5/007; F17C 2205/0134; F17C 2205/0323; F17C 2221/012; F17C 2250/043; F17C 2250/07; F17C 2265/065; F17C 2270/0168

(57) ABSTRACT

A hydrogen supply system may include: a common passage connected to a tank and through which hydrogen being filled into the tank and hydrogen supplied from the tank flow; a filling passage connecting the common passage and a filling port; a supply passage connecting the common passage and a hydrogen consumption device; a valve disposed in the supply passage and configured to reduce a pressure of the hydrogen supplied; a sensor disposed in a downstream section of the supply passage relative to the valve and configured to detect the pressure in the supply passage; and a controller. The controller may be configured to perform: a monitoring process for monitoring the pressure detected by the sensor while a power switch of a vehicle is off; and a notification process for executing a predetermined notification action to outside when the detected pressure exceeds a predetermined value in the monitoring process.

### CROSS REFERENCE TO RELATED APPLICATIONS

This application claims priority from Japanese Patent Application No. 2024-230563 filed on Dec. 26, 2024. The entire content of the priority application is incorporated herein by reference.

### TECHNICAL FIELD

The art disclosed herein relates to a hydrogen supply system.

### BACKGROUND ART

JP 2021-162155 describes a hydrogen supply system for use in a vehicle. The hydrogen supply system includes: a hydrogen tank; a common passage connected to the hydrogen tank and through which hydrogen being filled into the hydrogen tank and hydrogen supplied from the hydrogen tank flow; a filling passage connecting the common passage and a filling port of the vehicle and through which the hydrogen being filled into the hydrogen tank flows; and a supply passage connecting the common passage and a hydrogen consumption device and through which the hydrogen supplied from the hydrogen tank flows. The hydrogen consumption device consumes hydrogen to generate energy to drive the vehicle.

### SUMMARY

In the hydrogen supply system described above, a pressure reducing valve is provided on the supply passage. The pressure reducing valve reduces the pressure of the high pressure supplied hydrogen from the hydrogen tank to a predetermined pressure and supplies it to the hydrogen consumption device downstream thereof. However, if, for example, a malfunction occurs inside the pressure reducing valve, there is a risk that the high pressure supplied hydrogen may pass through the pressure reducing valve as it is. In such a case, the pressure will increase excessively in the section downstream relative to the pressure reducing valve. This specification provides a technology that can suppress an excessive increase in pressure in the section downstream from the pressure reducing valve in a hydrogen supply system.

The techniques disclosed herein are embodied by a hydrogen supply system configured to mounted in a vehicle. The hydrogen supply system may comprise: a hydrogen tank configured to store hydrogen; a common passage connected to the hydrogen tank and through which hydrogen being filled into the hydrogen tank and hydrogen supplied from the hydrogen tank flow; a filling passage connecting the common passage and a filling port of the vehicle and through which the hydrogen being filled into the hydrogen tank flows; a supply passage connecting the common passage and a hydrogen consumption device and through which the hydrogen supplied from the hydrogen tank flows; a pressure reducing valve disposed in the supply passage and configured to reduce a pressure of the hydrogen supplied from the hydrogen tank; a first pressure sensor disposed in a downstream section of the supply passage relative to the pressure reducing valve and configured to detect the pressure in the supply passage; and a controller connected to the first pressure sensor, wherein the controller may be configured to perform: a monitoring process for monitoring the pressure detected by the first pressure sensor while a power switch of the vehicle is off; and a notification process for executing a predetermined notification action to outside when the detected pressure exceeds a predetermined value in the monitoring process.

The techniques disclosed herein are embodied by another hydrogen supply system mounted in a vehicle. The hydrogen supply system may comprise: a hydrogen tank configured to store hydrogen; a common passage connected to the hydrogen tank and through which hydrogen being filled into the hydrogen tank and hydrogen supplied from the hydrogen tank flow; a filling passage connecting the common passage and a filling port of the vehicle and through which the hydrogen being filled into the hydrogen tank flows; a supply passage connecting the common passage and a hydrogen consumption device and through which the hydrogen supplied from the hydrogen tank flows and; a pressure reducing valve disposed in the supply passage and configured to reduce the pressure of the hydrogen supplied from the hydrogen tank; a shut-off valve disposed in an upstream section of the supply passage relative to the pressure reducing valve and configured to allow the supply passage to be passable and shut off; a first pressure sensor disposed in a downstream section of the supply passage relative to the pressure reducing valve and configured to detect the pressure in the supply passage; and a controller connected to the first pressure sensor, wherein the controller may be configured to perform: a monitoring process for monitoring the pressure detected by the first pressure sensor while a power switch of the vehicle is off; and a shut-off process for controlling the shut-off valve to shut off the supply passage when the detected pressure exceeds the predetermined value in the monitoring process.

### BRIEF DESCRIPTION OF DRAWINGS

FIG. 1 shows a configuration of a hydrogen supply system.

FIG. 2 shows a configuration of a pressure reducing valve and a relief valve.

FIG. 3 shows a flow diagram of a pressure suppression process performed by a controller.

### DETAILED DESCRIPTION

In a first aspect of the present teachings, a hydrogen supply system configured to be mounted in a vehicle may comprise: a hydrogen tank configured to store hydrogen; a common passage connected to the hydrogen tank and through which hydrogen being filled into the hydrogen tank and hydrogen supplied from the hydrogen tank flow; a filling passage connecting the common passage and a filling port of the vehicle and through which the hydrogen being filled into the hydrogen tank flows; a supply passage connecting the common passage and a hydrogen consumption device and through which the hydrogen being filled into the hydrogen tank flows; a pressure reducing valve disposed in the supply passage and configured to reduce a pressure of the hydrogen supplied from the hydrogen tank; a first pressure sensor disposed in a downstream section of the supply passage relative to the pressure reducing valve and configured to detect the pressure in the supply passage. The controller may be configured to perform: a monitoring process for monitoring the pressure detected by the first pressure sensor while a power switch of the vehicle is off; and a notification process for executing a predetermined notification action to outside when the detected pressure exceeds a predetermined value in the monitoring process.

In the hydrogen supply system described above, a first pressure sensor is installed in the section downstream of the pressure reducing valve in the supply passage. Therefore, when the power of the vehicle is on, the first pressure sensor can monitor the pressure in the section downstream of the pressure reducing valve. Furthermore, the hydrogen supply system is configured to monitor the detected pressure from the first pressure sensor even while the power switch of the vehicle is off. When the monitored detected pressure exceeds a predetermined value, the system performs the predetermined notification action to outside. According to this configuration, regardless of the vehicle's power switch on/off status, an early notification can be provided to passenger(s) of the vehicle and/or external entity such as a hydrogen station when a pressure increase exceeding a predetermined value occurs in the section downstream of the pressure reducing valve. As a result, measures concerning the pressure increase can be taken promptly, suppressing the pressure increase in the section downstream of the pressure reducing valve.

In a second aspect of the present teachings, in addition to the first aspect, the hydrogen supply system may further comprise a shut-off valve disposed in an upstream section of the supply passage relative to the pressure reducing valve and configured to allow the supply passage to be passable and be shut off. The controller may be further configured to perform a shut-off process for controlling the shut-off valve to shut off the supply passage when the detected pressure exceeds the predetermined value in the monitoring process. According to this configuration, shutting off the shut-off valve can prohibit the high pressure supplied hydrogen from passing through the pressure reducing valve. Thus, the pressure increase in the section downstream of the pressure reducing valve can be suppressed.

In a third aspect of the present teachings, a hydrogen supply system configured to be mounted in a vehicle may comprise: a hydrogen tank configured to store hydrogen; a common passage connected to the hydrogen tank and through which hydrogen being filled into the hydrogen tank and hydrogen supplied from the hydrogen tank flow; a filling passage connecting the common passage and a filling port of the vehicle and through which the hydrogen being filled into the hydrogen tank flows; a supply passage connecting the common passage and a hydrogen consumption device and through which the hydrogen supplied from the hydrogen tank flows; a pressure reducing valve disposed in the supply passage and configured to reduce the pressure of the hydrogen supplied from the hydrogen tank; a shut-off valve disposed in an upstream section of the supply passage relative to the pressure reducing valve and configured to allow the supply passage to be passable and shut off; a first pressure sensor disposed in a downstream section of the supply passage relative to the pressure reducing valve and configured to detect the pressure in the supply passage; and a controller connected to the first pressure sensor. The controller may be configured to perform: a monitoring process for monitoring the pressure detected by the first pressure sensor while a power switch of the vehicle is off; and a shut-off process for controlling the shut-off valve to shut off the supply passage when the detected pressure exceeds the predetermined value in the monitoring process. According to this configuration, regardless of the vehicle's power switch on/off status, if a pressure increase exceeding a predetermined value occurs downstream of the pressure reducing valve, the supplied hydrogen can be prohibited from passing through the pressure reducing valve by shutting off the shut-off valve. Consequently, excessive pressure increase in the section downstream of the pressure reducing valve can be suppressed.

In a fourth aspect of the present teachings, in addition to any of the above-mentioned first to third aspects, the controller may perform the monitoring process when the power switch of the vehicle is off and the vehicle is in middle of being filled with hydrogen. According to this configuration, the above effects can be achieved when the vehicle is in the middle of being filled with hydrogen, regardless of the status of communication/no communication between the hydrogen station and the vehicle.

In a fifth aspect of the present teachings, in addition to any of the above-mentioned first to fourth aspects, the hydrogen supply system may further comprise a second pressure sensor disposed in the filling passage or the common passage and configured to detect the pressure in the filling passage or the common passage. The controller may be connected to the second pressure sensor, and determine that the vehicle is in middle of being filled with hydrogen when the pressure detected by the second pressure sensor is increasing at a predetermined pressure increase rate. This allows the hydrogen supply system to identify the vehicle as being in the middle of being filled with hydrogen regardless of the communication/non-communication status between the hydrogen station and the vehicle.

### Embodiment

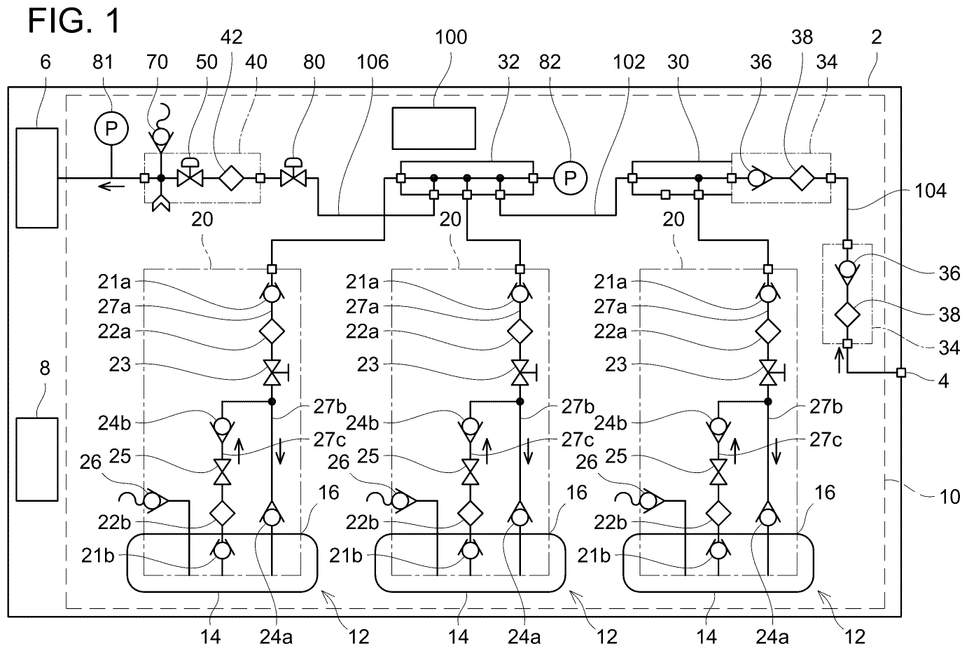

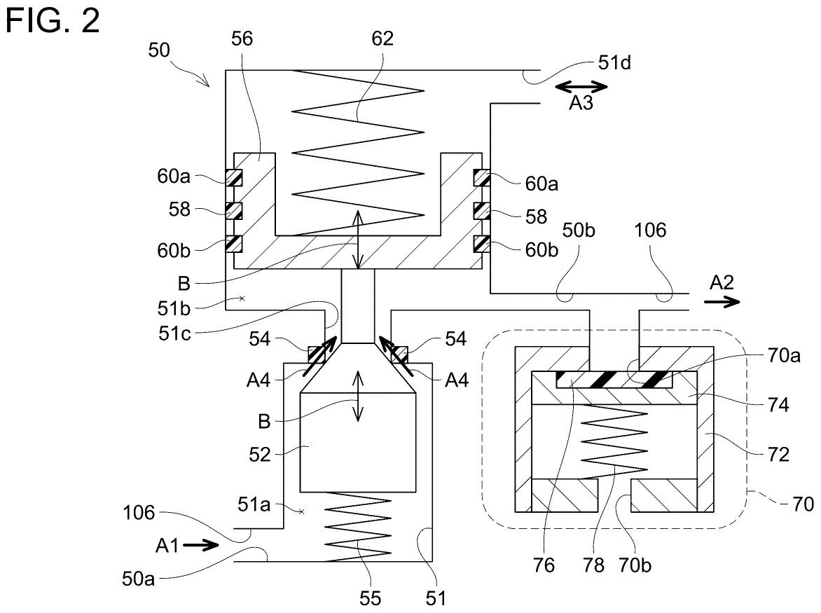

Referring to FIGS. 1 and 2, a hydrogen supply system 10 according to an embodiment is described. As shown in FIG. 1, the hydrogen supply system 10 is a device which can be mounted on a vehicle 2 equipped with, for example, a hydrogen consumption device 6, and which supplies hydrogen to the hydrogen consumption device 6. The hydrogen consumption device 6 is a device that consumes hydrogen to generate energy to drive the vehicle 2. The hydrogen consumption device 6 includes, for example, a hydrogen fuel cell and a hydrogen engine. The term “hydrogen” as described herein refers to hydrogen gas.

The hydrogen supply system 10 comprises a plurality of hydrogen tanks 12, a common passage 102, a filling passage 104, a supply passage 106, a plurality of check valve assemblies 34, a pressure reducing valve assembly 40, a shut-off valve 80, a first pressure sensor 81, a second pressure sensor 82, and a controller 100. Each hydrogen tank 12 is a sealed container that stores high pressure hydrogen inside. In one example, the hydrogen supply system 10 has three hydrogen tanks 12. The number of hydrogen tanks 12 is not limited to three, but may be one, two, or four or more.

The common passage 102 is a passage through which the hydrogen filled into the plurality of hydrogen tanks 12 and the hydrogen supplied from the plurality of hydrogen tanks 12 flow. The common passage 102 is connected to each of the plurality of hydrogen tanks 12. The common passage 102 has a plurality of distribution pipes 30, 32. The distribution pipes 30, 32 are piping members having a plurality of ports, so-called manifolds. A part of the common passage 102 is formed by the plurality of distribution pipes 30, 32. The common passage 102 is connected to the other passages 104, 106 and the plurality of hydrogen tanks 12 via the plurality of distribution pipes 30, 32. In one example, the common passage 102 has two distribution pipes 30 and 32. The distribution pipe 30 is connected to the filling passage 104, one of the plurality of hydrogen tanks 12, and the distribution pipe 32. The distribution pipe 32 is connected to the supply passage 106 and the other two hydrogen tanks 12 of the plurality of hydrogen tanks 12. The respective connections between the plurality of hydrogen tanks 12 and the plurality of distribution pipes 30 and 32 are not limited to this. For example, all the hydrogen tanks 12 may be connected to a single distribution piping 30, 32.

Each hydrogen tank 12 has a tank body 14 and a valve assembly 20. The tank body 14 has an interior storage space for storing high pressure hydrogen. The tank body 14 has an opening 16 that connects the storage space to the outside of the tank body 14. The opening 16 is located at an end of the tank body 14. The valve assembly 20 is secured to the opening 16. The valve assembly 20 is connected to the common passage 102. The valve assembly 20 provides a connection between the storage space of the tank body 14 and the common passage 102.

In one example, the valve assembly 20 has overflow prevention valves 21a, 21b, filters 22a, 22b, a manual valve 23, check valves 24a, 24b, a shut-off valve 25, a relief valve 26, a valve common passage 27a, a valve first passage 27b, and a valve second passage 27c. The valve common passage 27a is a passage for hydrogen to be distributed toward and from the tank body 14. The valve first passage 27b is a passage through which hydrogen toward the tank body 14 flows. The valve second passage 27c is a passage through which hydrogen from the tank body 14 flows. The valve common passage 27a has, in order from the common passage 102 side, the overflow prevention valve 21a, the filter 22a, and the manual valve 23. In the valve first passage 27b, the check valve 24a is located. In the valve second passage 27c, arranged in order from the tank body 14 side are the overflow prevention valve 21b, the filter 22b, the shut-off valve 25, and the check valve 24b.

In the valve assembly 20, the manual valve 23 is opened when filling the tank body 14 with hydrogen and when supplying hydrogen from the tank body 14. The shut-off valve 25 is a control valve whose opening and closing is controlled by the controller 100. During hydrogen filling, the shut-off valve 25 of the valve second passage 27c is closed. As a result, only the valve first passage 27b is connected to the valve common passage 27a, and the filled hydrogen from the common passage 102 passes through the overflow prevention valve 21a, filter 22a, and manual valve 23 to flow to the valve first passage 27b. The overflow prevention valve 21a here simply allows the filled hydrogen to pass therethrough. The filter 22a removes foreign matter and the like from the filled hydrogen. In the valve first passage 27b, the filled hydrogen from the valve common passage 27a flows in one direction from the upstream side (i.e., valve common passage 27a side) to the downstream side (i.e., tank body 14 side) by the check valve 24a.

During hydrogen supply, the shut-off valve 25 of the valve second passage 27c is open. As a result, the valve second passage 27c and the valve common passage 27a are connected, and the hydrogen supplied from the tank body 14 passes through the overflow prevention valve 21b, filter 22b, shut-off valve 25, and check valve 24b, and flows to the valve common passage 27a. The overflow prevention valve 21b here controls the flow rate of supplied hydrogen distributed from the tank body 14 to the supply passage 106. This prevents excessive flow of the supplied hydrogen from the hydrogen tank 12. The filter 22b removes foreign matter and the like from the supplied hydrogen. In the valve second passage 27c, the supplied hydrogen flows from the upstream side (i.e., tank body 14 side) to the downstream side (i.e., valve common passage 27a side) by the check valve 24b. After the filled hydrogen distributed in the valve common passage 27a passes through the manual valve 23 and the filter 22a, the flow rate of the supplied hydrogen distributed from the tank body 14 to the supply passage 106 is controlled by the overflow prevention valve 21a. At this time, the valve second passage 27c is connected not only to the valve common passage 27a but also to the valve first passage 27b. The supplied hydrogen whose flow rate in the valve common passage 27a is restricted by the overflow prevention valve 21a partially returns to the valve first passage 27b and circulates between the tank body 14 and the valve assembly 20. This maintains a uniform pressure inside the tank body 14.

The relief valve 26 connects the interior of the tank body 14 to the exterior of the tank body 14. The relief valve 26 is configured to be actuated when the pressure inside the tank body 14 exceeds a predetermined value. When the pressure inside exceeds the predetermined value, the relief valve 26 is opened to release the hydrogen stored inside the tank body 14 to the outside.

The filling passage 104 is a passage through which the hydrogen filled into the plurality of hydrogen tanks 12 flows. The filling passage 104 connects the common passage 102 to the filling port 4 of the vehicle 2. The filling port 4 of the vehicle 2 is connected, for example, to a filling hose of a hydrogen station. Thus, the filled hydrogen supplied to the vehicle 2 from the hydrogen station is filled into the plurality of hydrogen tanks 12 via the filling passage 104 and the common passage 102. The plurality of check valve assemblies 34 is located in the filling passage 104. Each check valve assembly 34 has the check valve 36 and the filter 38. Each check valve 36 is configured to prevent the filled hydrogen from flowing backwards toward the filling port 4, in which the direction from the filling port 4 to the common passage 102 is the forward flow. In each check valve assembly 34, the filter 38 is located upstream of the check valve 36. The filter 38 removes foreign matter and other particles in the filled hydrogen.

The supply passage 106 connects the common passage 102 to the hydrogen consumption device 6. The supply passage 106 is a passage through which the supplied hydrogen from the plurality of hydrogen tanks 12 flows. Accordingly, the supplied hydrogen from the plurality of hydrogen tanks 12 is supplied to the hydrogen consumption device 6 via the common passage 102 and the supply passage 106.

The pressure reducing valve assembly 40 is disposed in the supply passage 106. The pressure reducing valve assembly 40 has a filter 42, a pressure reducing valve 50, and a relief valve 70. The filter 42 is disposed upstream of the pressure reducing valve 50 and removes foreign matter and the like from the supplied hydrogen that flows to the pressure reducing valve 50. The pressure reducing valve 50 is configured to reduce the pressure of the supplied hydrogen from the plurality of hydrogen tanks 12. The relief valve 70 is disposed downstream of the pressure reducing valve 50 and is a safety valve that releases the supplied hydrogen outside of the supply passage 106 if the pressure downstream of the pressure reducing valve 50 is excessively increasing.

Referring to FIG. 2, the details of the configuration of the pressure reducing valve 50 and the relief valve 70 are described. Note that the filter 42 of the pressure reducing valve assembly 40 is omitted in FIG. 2.

As shown in FIG. 2, the pressure reducing valve 50 has an inlet 50a and an outlet 50b, a housing 51, a valve member 52, a valve seat 54, a valve spring 55, a piston 56, a sealing member 58, a pair of wear rings 60a and 60b, and a pressure regulating spring 62. The valve member 52, valve seat 54, valve spring 55, piston 56, sealing member 58, pair of wear rings 60a, 60b, and pressure regulating spring 62 are located in the housing 51. The housing 51 has a primary chamber 51a into which the high pressure supplied hydrogen flows from the inlet 50a (see bold arrow A1 in FIG. 2), a secondary chamber 51b out of which the pressure-reduced supplied hydrogen flows from the outlet 50b (see bold arrow A2 in FIG. 2), and a connecting port 51c that connects the primary chamber 51a and the secondary chamber 51b. The valve seat 54 is an annular member and is positioned on the primary chamber side of the connecting port 51c so as to surround the connecting port 51c. The valve seat 54 is constituted, for example, of a resin material. The valve member 52 has a needle shape having a tapered surface, for example. The valve member 52 is biased toward the valve seat 54 by the valve spring 55. The valve member 52 is arranged to open and close the connecting port 51c via the valve seat 54. Specifically, when the valve member 52 (i.e., the tapered surface) is in contact with the valve seat 54, the connecting port 51c is closed, and when the valve member 52 separates from the valve seat 54, the connecting port 51c is opened. The valve member 52 is connected to the piston 56 located in the secondary chamber 51b. The piston 56 is a plate-shaped member. The piston 56 works with the valve member 52 to open/close the valve member 52 (see arrow B in FIG. 2). The piston 56 is pressurized by the pressure regulating spring 62 toward the connecting port 51c. In the pressure reducing valve 50, the pressure regulating spring 62 adjusts the force exerted on the piston 56, and when the force pushing the piston 56 toward the connecting port 51c is greater than the force pushing the valve member 52 toward the valve seat 54, the valve member 52 opens. The force with which the piston 56 is pressed by the pressure regulating spring 62 adjusts the opening of the valve member 52. When the valve member 52 is opened at the adjusted opening degree, the high pressure supplied hydrogen flows from the primary chamber 51a into the secondary chamber 51b, and the pressure of the supplied hydrogen is adjusted to a certain pressure range by the flow rate of the hydrogen that flows in. The constant pressure range may be, for example, about 1.0 to 1.5 MPa.

Without limitation, the piston 56 comprises a protrusion protruding along the housing 51 at its outer periphery portion of the piston 56. The sealing member 58 and the pair of wear rings 60a and 60b are disposed on the outer periphery portion of the piston 56 with the sealing member 58 sandwiched between the pair of wear rings 60a and 60b. The piston 56 is configured to slide against the inner wall of the housing 51 via the sealing member 58 and the wear rings 60a, 60b when the piston 56 is moving. The piston 56 is not in direct contact with the inner wall of the housing 51. The sealing member 58 is a member that enhances the seal between the piston 56 and the housing 51. The sealing member 58 is an annular member and is constituted, for example, of a resin material or a rubber material. The wear rings 60a, 60b are annular protective members for preventing the piston 56 from being worn by sliding against the housing 51. The wear rings 60a and 60b are constituted, for example, of a resin material or the like. The housing 51 comprises a vent 51d above the piston 56, which vent 51d is connected to the outside of the pressure reducing valve 50 (see bold arrow A3 in FIG. 2). This allows the piston 56 to move smoothly.

The relief valve 70 is connected to the outlet 50b of the pressure reducing valve 50. The relief valve 70 has an inlet 70a and an outlet 70b, a housing 72, and a valve member 74, a valve seat 76, and a spring 78 disposed in the housing 72. The valve member 74 is a generally plate-shaped member and is arranged to open and close the inlet 70a of the relief valve 70. The valve seat 76 is interposed between the valve member 74 and the inlet 70a and is constituted, for example, of a resin material. The valve member 74 is biased by a spring 78 toward the inlet 70a. The relief valve 70 is configured to operate when the pressure of the supplied hydrogen downstream of the pressure reducing valve 50 in the supply passage 106 exceeds a predetermined value. When the pressure of the supplied hydrogen downstream of the pressure reducing valve 50 exceeds the predetermined value, the relief valve 70 opens the valve member 74 and releases the supplied hydrogen from the outlet 70b through the housing 72 to the outside of the supply passage 106. This predetermined value at which the relief valve 70 begins to operate is, for example, a range of greater than 2 MPa and 3 MPa or less.

The shut-off valve 80 is located in the section of the supply passage 106 upstream of the pressure reducing valve assembly 40. The shut-off valve 80 is configured to allow the supply passage 106 to be passable and shut off.

The first pressure sensor 81 is disposed downstream of the pressure reducing valve assembly 40 in the supply passage 106. The first pressure sensor 81 detects the pressure in the supply passage 106.

The second pressure sensor 82 is connected to one of the plurality of ports of the distribution pipe 32 in the common passage 102. The second pressure sensor 82 detects the pressure in the common passage. The location of the second pressure sensor 82 is not limited to the common passage 102. The second pressure sensor 82 needs only be capable of detecting the pressure in the passage through which the filled hydrogen toward the plurality of hydrogen tanks 12 flows. For example, the second pressure sensor 82 may be located in the filling passage 104. In this case, the second pressure sensor 82 may detect the pressure in the filling passage 104.

The controller 100 is communicatively connected to the relief valve 70 and the shut-off valve 80 and controls the operation of the relief valve 70 and the shut-off valve 80, respectively. The controller 100 is communicatively connected to the notification device 8 of the vehicle 2. The controller 100 controls the operation of the notification device 8.

The controller 100 includes, for example, a processor and a memory. The memory has a program stored in advance. The controller 100 can execute a pressure suppression process based on the program stored in the memory. The pressure suppression process includes, for example, a monitoring process, a notification process, and a shut-off process. The controller 100 is communicatively connected to the first pressure sensor 81 and the second pressure sensor 82. The controller 100 can receive the detected pressures P1 and P2 by the first pressure sensor 81 and the second pressure sensor 82. The controller 100 monitors the detected pressure P2 by the second pressure sensor 82 while the power switch of the vehicle 2 is turned off. The memory stores a rate of pressure increase of the second pressure sensor 82 during hydrogen filling. The rate of pressure increase is the amount of change in the detected pressure P2 by the second pressure sensor 82 per unit time. When the detected pressure P2 by the second pressure sensor 82 is increasing at the predetermined pressure increase rate stored in the memory, the controller 100 identifies the vehicle 2 as being in middle of being filled with hydrogen. This allows the hydrogen supply system 10 to identify that the vehicle 2 is being filled with hydrogen, regardless of the communication/non-communication status between the hydrogen station and the vehicle 2. The controller 100 executes the monitoring process while the power switch (not shown) of the vehicle 2 is turned off and when the vehicle 2 is in the middle of being filled with hydrogen. In the monitoring process, the controller 100 monitors the detected pressure P1 by the first pressure sensor 81.

When the detected pressure P1 by the first pressure sensor 81 exceeds a predetermined value in the monitoring process, the controller 100 executes the notification process. The predetermined value of the detected pressure P1 by the first pressure sensor 81 is a range of greater than 2 MPa and 3 MPa or less. In a variation, said predetermined value may be in the range of greater than 1.5 and 2 MPa or less. In another variation, said predetermined value may be greater than 3 MPa. In the notification process, the controller 100 performs a predetermined notification action to inform the outside of the hydrogen supply system 10 (e.g., the passenger(s) of the vehicle 2 or the hydrogen station) of the excessive pressure increase. The predetermined notification action may be to emit at least one of voice (including sound), light, vibration, or the like. Alternatively, the predetermined notification action may be to notify a communication terminal device communicatively connected to the controller 100 of the excessive pressure increase. In this case, the notification device 8 needs not be provided by the vehicle 2 and may be, for example, a communication terminal in the possession of the passenger(s) of the vehicle 2 or a communication terminal located at the hydrogen station.

When the detected pressure P1 by the first pressure sensor 81 exceeds a predetermined value in the monitoring process, the controller 100 executes a shut-off process in addition to the notification process described above. In the shut-off process, the controller 100 controls the shut-off valve 80 to shut off the supply passage 106.

In the hydrogen supply system 10 described above, a pressure reducing valve assembly 40 is provided on the supply passage 106. The pressure reducing valve 50 of the pressure reducing valve assembly 40 reduces the pressure of the high pressure (e.g., 70 MPa or 35 MPa) supplied hydrogen from the plurality of hydrogen tanks 12 to a predetermined pressure (e.g., about 1.0 to 1.5 MPa) and supplies it to the downstream hydrogen consumption device 6. However, if, for example, a malfunction occurs inside the pressure reducing valve 50, the high pressure supplied hydrogen may possibly pass through the pressure reducing valve 50 as it is (see arrow A4 in FIG. 2). For example, the contact between the valve member 52 and the valve seat 54 may cause the valve seat 54 to wear and the seal between the valve member 52 and the valve seat 54 to deteriorate. In such a case, the pressure would increase excessively in the section downstream relative to the pressure reducing valve 50.

In view of the above, in the hydrogen supply system 10 of this embodiment, the first pressure sensor 81 is arranged in the section downstream of the supply passage 106 relative to the pressure reducing valve assembly 40. Accordingly, when the power of the vehicle 2 is turned on, the pressure in the section downstream of the pressure reducing valve assembly 40 can be monitored by the first pressure sensor 81. In addition, the hydrogen supply system 10 is configured to monitor the detected pressure P1 by the first pressure sensor 81 even while the power switch of the vehicle 2 is turned off, and to perform a predetermined notification action to the outside when the monitored detected pressure P1 exceeds a predetermined value. According to this configuration, regardless of the on/off status of the power switch of the vehicle 2, an early notification can be made to the passenger(s) of the vehicle 2 and/or to the outside of the hydrogen station or the like that a pressure increase exceeding the predetermined value has occurred in the downstream section of the pressure reducing valve assembly 40. As a result, measures against the pressure increase can be taken quickly, and the pressure increase in the section downstream of the pressure reducing valve assembly 40 can be suppressed.

Furthermore, in this embodiment, the shut-off valve 80 is arranged in the section upstream of the supply passage 106 relative to the pressure reducing valve assembly 40. In this case, the controller 100 may be configured to perform a shut-off process to control the shut-off valve 80 to shut off the supply passage 106 when the detected pressure P1 exceeds a predetermined value in the monitoring process. According to this configuration, shutting off the shut-off valve 80 can prohibit the high pressure supplied hydrogen from passing through the pressure reducing valve assembly 40. Thus, the pressure increase in the section downstream of the pressure reducing valve assembly 40 can be reliably suppressed.

Furthermore, in this embodiment, the controller 100 executes the monitoring process when the power switch of the vehicle 2 is turned off and the vehicle 2 is in the middle of being filled with hydrogen. According to this configuration, the pressure increase in the section downstream from the pressure reducing valve assembly 40 can be suppressed when the vehicle 2 is in middle of being filled with hydrogen, regardless of the status of communication/no communication between the hydrogen station and the vehicle 2. However, the monitoring process of the controller 100 may be performed at a time other than those described above. The controller 100 needs only be executed at least while the power switch of the vehicle 2 is turned off. That is, the controller 100 may perform the monitoring process when the power switch of the vehicle 2 is turned off and the vehicle 2 is not in the middle of hydrogen filling (i.e., while the vehicle 2 is simply parked). In this case, the pressure increase in the section downstream from the pressure reducing valve assembly 40 can be suppressed even when the vehicle 2 is not being filled with hydrogen.

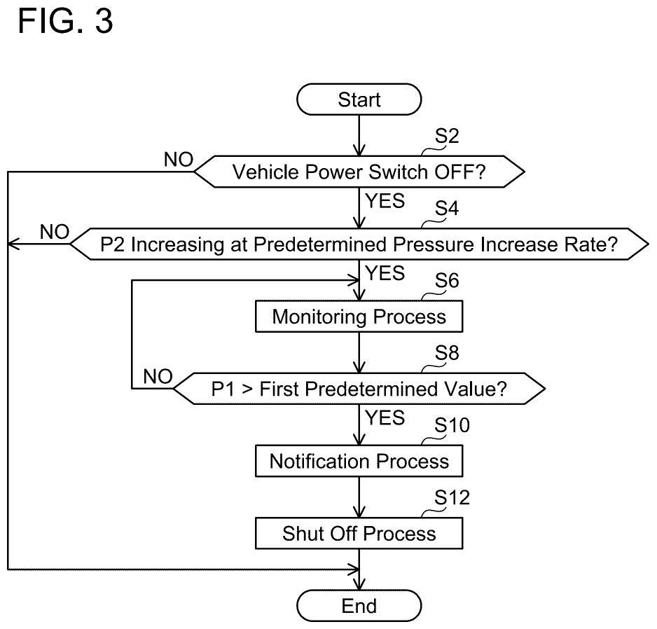

Referring to FIG. 3, an example of the pressure suppression process performed by the controller 100 is described.

In step S2, the controller 100 determines whether the power switch of the vehicle 2 is off. If the power switch of the vehicle 2 is off (YES in S2), the controller 100 proceeds to step S4. Otherwise (NO in S2), the controller 100 terminates the pressure suppression process.

In step S4, the controller 100 determines whether the detected pressure P2 by the second pressure sensor 82 is increasing at a predetermined pressure increase rate. If the detected pressure P2 is increasing at the predetermined pressure increase rate (YES in S4), the controller 100 identifies the vehicle 2 as being in the middle of filled with hydrogen and proceeds to the monitoring process in step S6. Otherwise (NO in S4), the controller 100 terminates the pressure suppression process.

In step S6, the controller 100 performs the monitoring process. In step S8, the controller 100 determines whether the detected pressure P1 by the first pressure sensor 81 exceeds a predetermined value in the monitoring process. If the detected pressure P1 by the first pressure sensor 81 exceeds the predetermined value (YES in S8), the controller 100 proceeds to the shut-off process in step S10. Otherwise (NO in S8), the controller 100 continues the monitoring process of step S6.

In step S12, the controller 100 performs the notification process.

In step S10, the controller 100 executes the shut-off process.

In steps S2-12 above, the controller 100 completes the pressure suppression process. As a result, the pressure increase in the section downstream from the pressure reducing valve 50 can be suppressed.

However, the series of pressure suppression processes implemented by the controller 100 is not limited to the configuration of the embodiment described above. In a variant, the controller 100 may reverse the order of the notification process in step S10 and the shut-off process in step S12. In another variant, the controller 100 may execute only the shut-off process in step S12 without executing the notification process in step S10. In another variant, the controller 100 may execute only the shut-off process of S10 without executing the shut-off process of step S12. The configuration of either variant can allow the pressure increase in the section downstream of the pressure reducing valve assembly 40 to be suppressed.

Although not limited, in this embodiment, the pressure reducing valve assembly 40 comprises the relief valve 70 in addition to the pressure reducing valve 50. The hydrogen release of the relief valve 70 also suppresses the pressure increase in the section downstream of the pressure reducing valve 50. On the other hand, the relief valve 70 continues to release hydrogen that has passed through the pressure reducing valve 50 to the outside while the pressure of the supplied hydrogen exceeds a predetermined value downstream of the pressure reducing valve 50 in the supply passage 106. By employing this technology, this situation where hydrogen continues to be released from the relief valve 70 can be avoided.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A hydrogen supply system configured to be mounted in a vehicle, the hydrogen supply system comprising:
a hydrogen tank configured to store hydrogen;
a common passage connected to the hydrogen tank and through which hydrogen being filled into the hydrogen tank and hydrogen supplied from the hydrogen tank flow;
a filling passage connecting the common passage and a filling port of the vehicle and through which the hydrogen being filled into the hydrogen tank flows;
a supply passage connecting the common passage and a hydrogen consumption device and through which the hydrogen supplied from the hydrogen tank flows;
a pressure reducing valve disposed in the supply passage and configured to reduce a pressure of the hydrogen supplied from the hydrogen tank;
a first pressure sensor disposed in a downstream section of the supply passage relative to the pressure reducing valve and configured to detect the pressure in the supply passage; and
a controller connected to the first pressure sensor,
wherein the controller is configured to perform:
a monitoring process for monitoring the pressure detected by the first pressure sensor while a power switch of the vehicle is off; and
a notification process for executing a predetermined notification action to outside when the detected pressure exceeds a predetermined value in the monitoring process.

2. The hydrogen supply system according to claim 1, further comprising a shut-off valve disposed in an upstream section of the supply passage relative to the pressure reducing valve and configured to allow the supply passage to be passable and be shut off,
wherein the controller is further configured to perform a shut-off process for controlling the shut-off valve to shut off the supply passage when the detected pressure exceeds the predetermined value in the monitoring process.

3. A hydrogen supply system configured to be mounted in a vehicle, the hydrogen supply system comprising:
a hydrogen tank configured to store hydrogen;
a common passage connected to the hydrogen tank and through which hydrogen being filled into the hydrogen tank and hydrogen supplied from the hydrogen tank flow;
a filling passage connecting the common passage and a filling port of the vehicle and through which the hydrogen being filled into the hydrogen tank flows;
a supply passage connecting the common passage and a hydrogen consumption device and through which the hydrogen supplied from the hydrogen tank flows;
a pressure reducing valve disposed in the supply passage and configured to reduce a pressure of the hydrogen supplied from the hydrogen tank;
a shut-off valve disposed in an upstream section of the supply passage relative to the pressure reducing valve and configured to allow the supply passage to be passable and shut off;
a first pressure sensor disposed in a downstream section of the supply passage relative to the pressure reducing valve and configured to detect the pressure in the supply passage; and
a controller connected to the first pressure sensor,
wherein the controller is configured to perform:
a monitoring process for monitoring the pressure detected by the first pressure sensor while a power switch of the vehicle is off; and
a shut-off process for controlling the shut-off valve to shut off the supply passage when the detected pressure exceeds a predetermined value in the monitoring process.

4. The hydrogen supply system according to claim 1, wherein the controller performs the monitoring process when the power switch of the vehicle is off and the vehicle is in middle of being filled with hydrogen.

5. The hydrogen supply system according to claim 4, further comprising a second pressure sensor disposed in the filling passage or the common passage and configured to detect the pressure in the filling passage or the common passage,
wherein the controller is connected to the second pressure sensor, and determines that the vehicle is in middle of being filled with hydrogen when the pressure detected by the second pressure sensor is increasing at a predetermined pressure increase rate.
